(19) United States
(12) Patent Application Publication
(10) Pub. No.: US 2009/0267747 A1
(43) Pub. Date: Oct. 29, 2009

(54) Security and Data Collision Systems and Related Techniques for Use With Radio Frequency Identification Systems

(76) Inventors: Ronald L. Rivest, Arlington, MA (US); Daniel W. Engels, Lincoin, MA (US); Sanjay Sarma, Belmont, MA (US); Stephen A. Weis, Somerville, MA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/409,282

(22) Filed: Mar. 23, 2009

Related U.S. Application Data
(63) Continuation of application No. 10/769,299, filed on Jan. 30, 2004, now abandoned.
(60) Provisional application No. 60/459,518, filed on Mar. 31, 2003.

(51) Int. Cl. H04Q 5/22

(52) U.S. Cl. 340/10.51; 340/10.1; 340/10.2

(57) ABSTRACT

In accordance with the present invention, a radio frequency identification (RFID) tag for use with an RFID system which includes one or more RFID tag readers, includes a tag communication device adapted to communicate with each of the one or more tag readers, a one-way hash function stored on the RFID tag, and a memory having stored therein a metaID. The tags may be locked and unlocked. The system includes a reader and a database. The system communicates with the tags via a forward channel and a backward channel. The present invention can singulate one tag from several responding tags and acquire the ID for the singulated tag.

### CROSS REFERENCE TO RELATED APPLICATIONS

This application claims priority under 35 U.S.C. §119 (e) to provisional application Ser. No. 60/459,518 filed Mar. 31, 2003; the disclosure of which is hereby incorporated by reference.

### STATEMENT REGARDING FEDERALLY SPONSORED RESEARCH

Not Applicable.

### FIELD OF THE INVENTION

This invention relates generally to Radio Frequency Identification (RFID) systems and more particularly to a system and techniques for providing selective access to RF tags and for reducing the number of collisions between data transmitted to and from a plurality of different RF tags in an RFID system.

### BACKGROUND OF THE INVENTION

As is known in the art, in many applications including but not limited to security access control, manufacturing, supply chain management, communications and retail inventory control, there has been a trend to provide systems having the ability to track uniquely identified items, devices, and services (collectively called objects). The identifier may take many forms, such as a given name or number (e.g., a social security number or UPC code) or a characteristic of the object (e.g. a fingerprint).

So-called “bar codes” and optical bar code readers are examples of one type of prior art tracking system often used in the consumer products and retail industries. The bar codes are typically provided as part of product packaging or on labels attached to products. The optical bar code readers are often placed at a cashier location or other point of sale. Typically, when a consumer purchases one of more products, each product and associated bar code are brought to the bar code reader where the bar codes are optically scanned and product information (such as price, type of product, etc. . . . ) is fed to a database.

As is also known, Radio Frequency identification (RFID) systems are another type of tracking system that can be used to track objects. In general, RFID systems include a radio frequency tag, or transponder and an RF tag reader, or transceiver. Tag readers access the contents of a tag by broadcasting an RF signal. Tags respond by transmitting resident data back to the tag reader. The data resident on the tags usually includes a serial number. While some RFID systems have conventionally been used in applications such as microchip fabrication, automobile manufacturing, and even cattle herding, advances in silicon manufacturing technology are making low-cost RFID, or “smart label”, systems economical as a replacement for optical barcodes on consumer and retail items.

One advantage of an RFID system compared with an optical bar code system is that data may be automatically read from tags through non-conducting materials such as paper or cardboard (i.e. it is not necessary that the tag be in plain sight of the tag reader). Furthermore, tags are typically provided from a silicon-based microchip that allows the tag to include functionality beyond simple identification. This functionality might range from integrated sensors, to read/write storage, to encryption and access control support. Typical implementations of RFID systems allow read operations at a range of several meters, and at a rate of several hundred reads per second, offering a great performance advantage over prior art techniques such as optical bar codes and associated readers, for example. One embodiment of a RFID system is described in copending U.S. patent application Ser. No. 09/379,187 filed on Aug. 20, 1999 which claims the benefit of application No. 60/097,254 filed Aug. 20, 1998.

The potential benefits of a pervasive low-cost RFID system are enormous. Worldwide, over about one billion bar codes are scanned daily. However, bar codes are scanned typically only once during checkout. By integrating a unified identification system on all levels of a supply chain, for example, all parties involved in the lifespan of a product could benefit. This includes not only manufactures and retailers, but also consumers, regulatory bodies such as the United States Food and Drug Administration (FDA), and even the waste disposal industry.

One drawback to the universal deployment of RFID devices and related systems with respect to consumer items, however, is that if such RFID tags are universally deployed, such universal deployment may expose users of the systems and devices to security and privacy risks which are not typically present in closed manufacturing environments.

One possible risk, for example, is corporate espionage. Retail inventory labeled with tags which respond in full to any tag reader (rather than a specific tag reader) could be monitored and tracked by a business' competitors. Another risk is that personal privacy may also be compromised by nearby “snoops” extracting data from unprotected tags. A further risk is the tracking of an individual's location by tracking the tags that the individuals may carry.

Most manufacturing processes already deploying RFID systems are for higher value items, allowing tag costs in the United States (U.S.) to be in the $0.50-$1.00 dollar price range. These relatively high cost tags offer stronger security properties by supporting basic cryptographic primitives, and being encased in tamper resistant casing similar to smart card designs.

To achieve significant consumer market penetration, however, it may be necessary to price RF tags in the range of about $0.05 U.S. dollars (USD) to about $0.10 USD. Also, another important characteristic is that the RFID tags will need to be easily incorporated into most paper packaging. In this price range, providing strong cryptographic primitives is relatively difficult and not a realistic option using conventional technology and approaches.

### SUMMARY OF THE INVENTION

In accordance with the present invention, a radio frequency identification (RFID) tag includes a tag communication device adapted to communicate with one or more tag readers, a hash function circuit for hashing a key value to obtain a metaID, and a memory having stored therein a metaID.

With this particular arrangement, an RFID tag that selectively provides access to information stored thereon is provided. Such an RFID tag finds use in an RFID system which includes one or more RFID tag readers. By equipping each RFID tag with a one-way hash function, a tag owner can “lock” a tag by selecting a random key value and then writing the key's hash value to the tag's metaID. The tag now enters a so-called “locked state.” The RFID tags will operate in either a locked or unlocked state but in the locked state, the RFID tag does not allow detailed (or in some cases any) information to be read. Once locked, the tag responds to all queries with only its metaID. In one embodiment, a hash function is used and the “metaID” is stored in a re-writeable memory on the RFID tag.

Both the key and the metaID can be stored in an off-tag storage location (e.g. an off-tag database). To unlock the tag, a legitimate user of the tag queries the tag for it's metaID, and looks up the associated key value from the storage location (e.g. the database) in which the key and the metaID are stored. The owner then sends the key value to the tag. The tag hashes the received key value and compares it to its stored metaID. If the values match, the tag unlocks itself. Based on the difficulty of inverting a one-way hash function, this scheme protects tags from unauthorized readers and only requires implementing a hash function on the tag, and key management on the back-end.

In accordance with a still further aspect of the present invention, a technique for unlocking a tag includes querying a metaID from the tag, using the metaID to look up an appropriate key in a database, and transmitting the key to the tag. Once the tag receives the key, the tag hashes the key and compares it to the stored metaID. If the values match, the tag unlocks itself and offers its full functionality to any nearby readers. With this particular arrangement, a relatively low-cost, simple security technique based on a one-way hash function is provided. Each hash-enabled tag has a portion of memory reserved for a temporary metaID, and will operate in either a locked or unlocked state.

In accordance with a further aspect of the present invention, an RFID system includes a plurality of RFID tags, each of the RFID tags having a metaID and equipped with a one-way cryptographic function, an off-tag storage device having stored therein a key and the metaID and one or more tag readers adapted to query a tag for it's metaID, use the metaID to look up the associated key value from the storage location and then provide the key value to the tag. With this particular arrangement, a technique for avoiding privacy and security risks of a low-cost RFID system that can be deployed in everyday consumer items is provided. The tag decrypts the received key value and compares it to its stored metaID. If the values match, the tag unlocks itself. Based on the difficulty of the cryptographic function, this technique protects tags from unauthorized readers. In one embodiment, a cryptographic hash function is used and the “metaID” is stored in a re-writeable memory.

In another embodiment, the metaID is provided by using a hash function. The hash function technique is extended by using a random number generator. While in a locked state, tags respond to reader queries by generating a random number, “r”, and responding with the pair (r, hash(ID∥r)). Upon receiving a tag's response, a legitimate owner can hash each of their known IDs appended to the random number, r, until they find a match. With this particular technique, a method for embedding RFID tags in consumer products while reducing or minimizing the physical tracking of the products or of individuals (e.g. individuals carrying the products) is provided. Even if tag contents are protected by an access control scheme, predictable tag behavior may allow the tracking of people carrying RFID-enabled products. To prevent tracking, tag responses must appear random to unauthorized readers, but must still be recognizable by legitimate readers.

In yet another embodiment, a stronger variant of this technique is to employ a pseudo-random function ensemble, F=fᵢ, rather than a one-way hash that may leak ID information. Assuming each tag shares a key, k, with its owner, tags will now respond by XORing their ID value with the value of fₖ called on a random value, i.e. (r, ID XOR Fₖ(r)). The above-arrangement provides a technique for avoiding privacy and security risks of a low-cost RFID system that can be deployed in everyday consumer items is provided. Additionally, a random number may be generated and appended to the identification of the tag to provide a relatively long tag identifier which then can be used in a cryptographic or other function to maintain the privacy of the tag identity.

In accordance with a still further aspect of the present invention, an asymmetric channel secret key negotiation includes generating a random value, “r,” and sending it to the reader. The reader will then send (s XOR r) to the tag, which can easily recover the value “s.” With this particular arrangement, assuming a secure backward channel, the tag information is kept secure. This technique relies, at least in part, upon the asymmetry of signal strength between tags and readers, which is a unique property of RFID systems. The reader-to-tag, or forward channel, is a much stronger signal relative to the tag-to-reader, or backward channel. Eavesdroppers may monitor the forward channel at a range of hundreds of meters versus a backward channel range of just a few meters. RFID systems may leverage this asymmetry to transmit secret values between tags and readers. Assuming eavesdroppers are outside the backward channel range, tags may broadcast their responses in the clear. However, a reader wishing to transmit a secret value, s, to a tag cannot send it over the forward channel securely.

In accordance with a still further aspect of the present invention, an anti-collision methodology includes the reader requesting a next ID bit from all active tags and in response to a detected collision, the reader responds with the bit value of the tags which should proceed. With this particular arrangement a modified silent tree walking anti-collision technique is provided. By having the reader request the next ID bit from all active tags, and by having the reader responds with the bit value of the tags which should proceed in response to a detected collision, a relatively simple anti-collision algorithm corresponding to a binary tree waking technique is provided. Assuming unique IDs, at the end of the protocol, only a single tag will remain active.

Unfortunately, a reader may transmit the entire ID value of the tag it isolates on the forward channel. To address this issue a secret sharing technique is used. While performing a tree walking algorithm, when no collision is detected, the reader will record the value and position of the bit and simply direct all tags to proceed. Outside the backward channel range, the bit value is a shared secret among all tags and the reader. When a collision is detected, the reader may use these stored, secret bits to indicate which tags should proceed with the protocol. For example, if a bit s is a shared secret, the reader can respond to a collision with either s or s̅ to indicate which portion of the tag population should proceed with the protocol. An eavesdropper on the forward channel has no information on s, and gains no information on which tags are active. With this particular arrangement, a variant of binary tree walking technique that does not broadcast insecure tag IDs on the forward channel, and does not adversely affect performance is provided.

### BRIEF DESCRIPTION OF THE DRAWINGS

The foregoing features of the invention, as well as the invention itself may be more fully understood from the following detailed description of the drawings, in which:

FIG. 1 is a block diagram of an automatic radio frequency identification (RFID) system that illustrates forward and backward channels;

FIG. 2 is a block diagram of an automatic radio frequency identification (RFID) system that illustrates a tag reader unlocking a hash-locked tag;

FIG. 3 is a block diagram of an automatic radio frequency identification (RFID) system that illustrates a tag reader unlocking a randomized hash-locked tag;

FIGS. 4A and 4B are a set of diagrams which illustrate a protocol for collision-free data transmission from RFID tags;

FIG. 5 is a flow chart of a process for storing a hashed key and ID;

FIG. 6 is a flow chart of a process for unlocking a tag using a hashed key;

FIG. 7 is a flowchart of a process for unlocking a tag using a randomized hash lock;

FIG. 8 is a flow chart of a process for performing binary tree walking; and

FIG. 9 is as flow chart of a process for performing randomized tree walking.

### DESCRIPTION OF THE PREFERRED EMBODIMENTS

Before providing a detailed description of the figures, some introductory concepts are explained. The below description describes certain security risks of low-cost radio frequency identification (RFID) tags and describes how to address such security risks. In the description below, certain limitations regarding the operation of the system are taken into consideration. For example, the RFID tags have a minimalist design, are passive, and will provide read-only identification functionality. Also, the tags contain only a few hundred bits of storage, and have a limited operating range of a few meters. Cost requirements limit the tag's gate count such that neither public-key nor symmetric cryptography may be feasibly supported. Furthermore, performance requirements dictate that at least 100-200 tags must be able to be read each second.

In view of the above and in accordance with the present invention, it has been recognized that Radio Frequency Identification (RFID) transponder, or tags, require access control functionality to prevent unauthorized parties from reading sensitive data. Narrow cost constraints limit the resources available for providing security functions. An access control implementation on low-cost RFID devices must be hardware efficient, yet provide adequate security. It is also appreciated in accordance with the present invention that if the tag is made as inexpensively as possible, the burden of supporting security is placed, in large part on the readers, whose costs are less restrictive.

Unless otherwise noted below, it is assumed that no secure memory exists on the tag itself and that tags will not be vulnerable to physical analysis methods that may reveal their entire contents. It is not assumed that attacks cannot be conducted on a wide scale without detection. Tags may be equipped with a physical contact channel for critical functions, or for “imprinting” tags with secret keys. Additionally, the tag packaging may contain some optical information, such as a barcode or human-readable digits that may be used to corroborate tag data.

The tag readers are assumed to have a secure connection to a back-end database and the readers may only read tags from within the 2 meter tag operating range, the reader-to-tag channel (also referred to as a forward channel) is assumed to be broadcast with a signal strong enough to monitor from long-range, perhaps 100 meters. The tag-to-reader channel (also referred to as a backward channel) is relatively weaker compared with the forward channel and may only be monitored by eavesdroppers within a tag's 2 meter operating range. Generally, it will be assumed that eavesdroppers may only monitor the forward channel without detection.

Tags will also be assumed to have a mechanism to reveal their presence (also referred to as a “ping mode,” “ping response” or more simply a “ping”). Anyone (i.e. any tag reader or other device) may send a signal requesting identification of a tag (also referred to as a “ping request” or more simply a “query”) to which tags respond by emitting or otherwise providing a non-identifying signal. Tags are also equipped with a so-called “kill” command, which renders the tag permanently inoperable. The kill command may be assumed to be a slow operation that physically disables the tags perhaps by disconnecting the antenna or blowing a fuse.

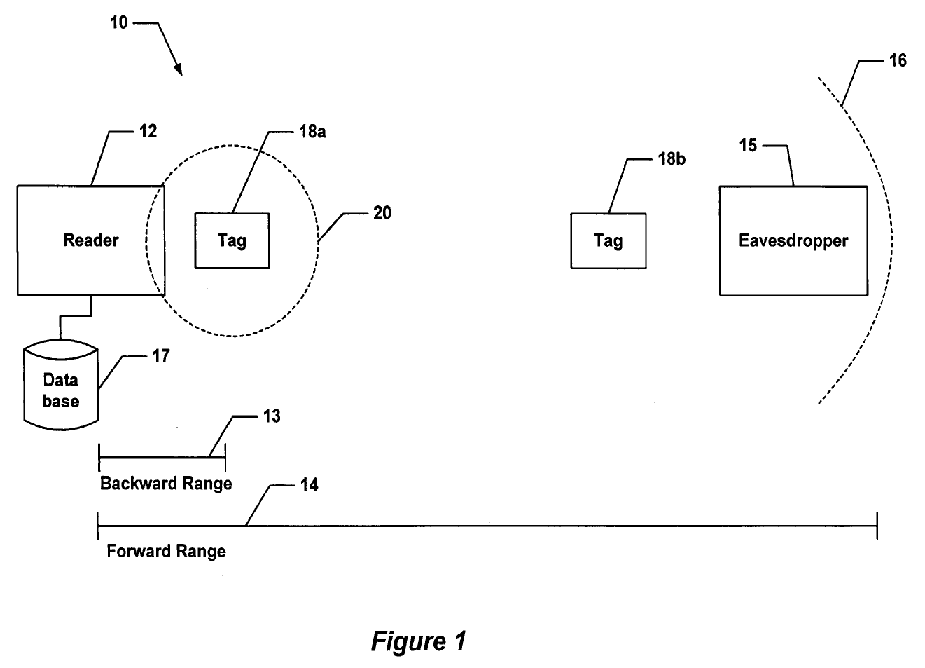

Referring now to FIG. 1, a block diagram of an RFID system 10 is shown. The RFID system 10 includes one or more tag readers 12 (only one reader 12 being here shown for simplicity and clarity in this description) which emits or otherwise provides signals along a so-called forward channel within a first forward range 14, an edge of which is marked by dashed line 16. Reader 12 is provided having a secure connection to a back-end database 17.

The RFID system 10 further includes one or more tags 18a, 18b generally denoted 18 (only two tags 18 being here shown for simplicity and clarity in the description). Each of the tags 18 is responsive to signals provided by the tag reader 12. Tag 18a emits or otherwise provides response signals in a tag operating range that is marked by dashed circle 20. Readers 12 may only read tags 18 from within the tag operating range 20. In this exemplary embodiment, the tag operating range corresponds to about two meters and thus readers 12 may only read tags 18 when the tags 18 are within about two meters of the tag reader. In other embodiments, however, it may be desirable to provide a tag operating range which is greater or less than two meters.

The system 10 may also include one or more tags 18b which is similar to tag 18a. Assuming tag 18b is provided having the same operating range as tag 18a, then the operating range of the tag 18b is such that the tag 18b cannot communicate with the reader 12 on the tag-reader communication channel (i.e. the backward channel 13). Thus, as shown in FIG. 1, the reader 12 is able detect tag 18a but is not able detect tag 18b.

However, since the tag 18b is within the forward channel range 14 of the reader 12, the reader can provide signals to the tag 18b. Thus, while the tag 18b can receive signals the reader 12, the reader 12 cannot receive signals from the tag 18b while the tag 18b is spaced from the reader 12 by a distance that is greater than the tag operating range.

In this exemplary embodiment, the reader-to-tag channel (i.e. the forward channel 14) is assumed to be broadcast with a signal strong enough to be monitored by an eavesdropper 15 (or other nefarious user) from a relatively long-range, (e.g., 100 meters). Thus, signals on the tag-to-reader channel 13 (also referred to as a backward channel) are relatively weak compared with signals on the forward channel 14. Accordingly, signals on the tag-to-reader channel 13 may only be monitored by an eavesdropper 15 within a tag's two meter operating range. Since the distance to monitor the backward channel 13 is relatively small, it is assumed that an eavesdropper 15 can be detected by physical security or other means. It is also assumed that an eavesdropper 15 may monitor the forward channel 14 without detection. The eavesdropper 15, however, cannot monitor the tag responses.

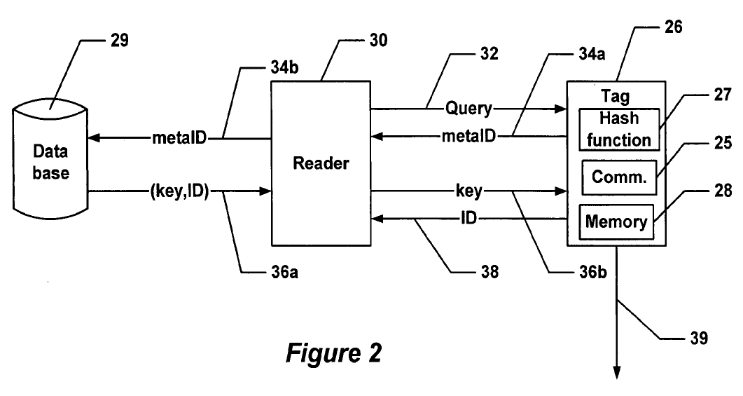

Referring now to FIG. 2, an RFID tag 26, which may for example be similar to the tags 18, described above in conjunction with FIG. 1, includes a memory 28 having stored therein a value corresponding to a so-called “metaID.” The metaID is a value that corresponds to a hash of a random key. The purpose of the metaID is to ensure that the tag 26 does not respond to signals from unauthorized users. The tag 26 further includes a communication device 25 for communicating with tag readers, and a hash cryptographic function element 27 for providing a cryptographic function to a key to obtain a metaID. The tag may be “locked” by the tag owner (or other authorized person) by storing the metaID in the memory 28. The tag's metaID value may be stored in the memory either over a forward channel (e.g. channel 14 in FIG. 1 which may be provided as an RF channel) or over a physical contact channel 39. Use of a physical contact channel 39 provides added security.

Upon receipt of a metaID value, the tag 26 enters its locked state. After locking a tag, the owner stores both the key and the corresponding metaID in a back-end database 29 which may be similar to the database 17 described above in conjunction with FIG. 1. While in the locked state, the tag 26 responds to all queries by providing its metaID and offers no other functionality or information.

To unlock the tag 26, the reader 30 (which may be similar to the reader 12 described above in conjunction with FIG. 1), emits or otherwise provides a query signal 32 to the tag 26. In response to the query 32, the tag 26 provides the metaID as indicated at 34a. The metaID is provided at 34b to the database 29 where the metaID is used to look up the appropriate key in the back-end database 29. The database 29 (or other transmission apparatus) transmits the key to the tag as shown at 36a and 36b. The tag 26 hashes the key and compares it to the stored metaID. If the values match, tag 26 unlocks itself and offers its full functionality to any nearby readers as indicated at 38.

In a preferred embodiment, to prevent hijacking of unlocked tags, the tags should only be unlocked briefly to perform a function before being locked again. When the tags are locked again, they are assigned a new metaID.

Based upon the difficulty of inverting a one-way hash function, the above technique prevents unauthorized readers from reading tag contents. Furthermore, spoofing attempts may be detected under this scheme, although not prevented. An adversary may query a tag (e.g. tag 26) for its metaID, then later spoof that tag to a legitimate reader in a replay attack. A legitimate reader (e.g. reader 30 in FIG. 2) will reveal the key to the spoofed tag. However, the reader may check the ID of the tag against the back-end database (e.g. database 29) to verify that it is associated with the proper metaID. Detecting an inconsistency alerts a reader that a spoofing attack may have occurred.

The hash-lock technique only requires implementing a hash function on the tag, and managing keys on the back-end. Also, this technique may be extended to provide access control for multiple users or to other tag functionality, such as write access. Tags may still function as object identifiers while in the locked state by using the metaID for database lockups. This allows users, such as third-party subcontractors, to build their own databases, and to take advantage of tag functionality without necessarily owning the tags.

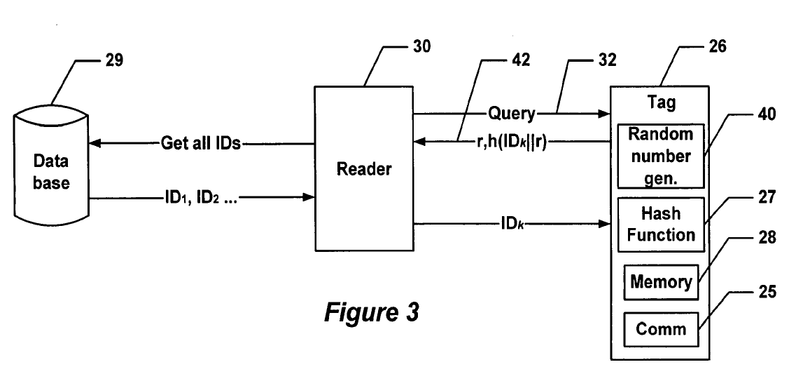

Since the metaID acts as an identifier, it has in accordance with the present invention, been recognized that under the technique described above in conjunction with FIG. 2, tracking of an individual is possible. Preventing the tracking of individuals motivates one to add an additional mode of operation (i.e. a “prevent-tracking mode”). While in this prevent-tracking mode, a tag must not respond predictably to queries by unauthorized users (e.g. an eavesdropper or other nefarious user), but the tag must still be identifiable by legitimate readers. FIG. 3 describes one exemplary technique to implement a prevent-tracking mode based on one-way hash functions.

Referring now to FIG. 3, in which like elements of FIG. 2 are provided having like reference designations, as in the system of FIG. 2, tags 26 are equipped with a random number generator 40. Tags 26 respond to queries 32 from reader 30 by generating a random value, r, then hashing its ID (i.e. the tag ID) concatenated with r, and sending both values to the reader 30 as indicated at 42. That is, tags 26 respond to queries 32 with the pair (r, h(ID)|r)), where r is chosen uniformly at random.

A legitimate reader (e.g. reader 30) identifies one of its tags by performing a brute-force search of its known IDs, hashing each of them concatenated with r until it finds a match. Although perhaps impractical for applications in which timing or speed is important (e.g. in a retail application), this mode is feasible for consumers who own a relatively small number of tags. Also, in those applications in which timing or speed is important (e.g. in a retail application) relatively high speed processors could be used.

Unfortunately, a one-way hash function is only guaranteed to be difficult to invert. Although it may suffice in practice, it could theoretically leak information about the ID. To address this issue, the system may be provided such that each tag 26 shares a unique secret key k with the reader 30, and supports a pseudo-random function ensemble, F−{fₙ}_{neN}. When queried, tags 26 will generate a random value r, and reply with the result of a logical EXCLUSIVE OR (also known as XOR) function (r, ID [symbol] fₖ(r)). The reader 30 will once again perform a brute-force search, using all its known ID/key pairs to search for a match. A minor fix allows readers to only store tag keys on the back-end, without needing to also store the tag IDs. Tags may pad their ID with zeroes, and reply with (r, (ID∥0^{t}) [symbol] fₖ(r)). Readers may identify tags by computing fₖ(r) for all their known keys, XORing it with the second part of the tag's response, and searching for a value ending in t zeroes. To anyone without the key value, the tag's output is random and meaningless.

It is debatable whether Pseudo-Random Function (PRF) ensembles may be implemented with significantly fewer resources than symmetric encryption, so such an approach may or may not be practical for current low-cost RFID tags. Many symmetric encryption algorithms employ PRFs as a core building block in a Luby-Rackoff style design.

Another security concern is the strong signal of the reader-to-tag forward channel. Eavesdroppers may monitor this channel from hundreds of meters, and possibly derive tag contents from it. Of particular concern is the binary tree walking anti-collision technique because the reader broadcasts each bit of the singulated tag's ID.

Assume a population of tags share some common ID prefix, such as a product code or manufacturer ID. To singulate tags, the reader requests all tags to broadcast their next bit. If there is no collision, then all tags share the same value in that bit.

A long-range eavesdropper can only monitor the forward channel, and will not hear the tag response. Thus, the reader and the tags effectively share a secret, namely the bit value. If no collisions occur, the reader may simply ask for the next bit, since all tags share the same value for the previous bit. When a collision does occur, the reader needs to specify which portion of the tag population should proceed.

Since tags may share a some common prefix, the reader may obtain this prefix on the backward channel. A shared secret prefix may be used to conceal the value of the unique portion of the IDs.

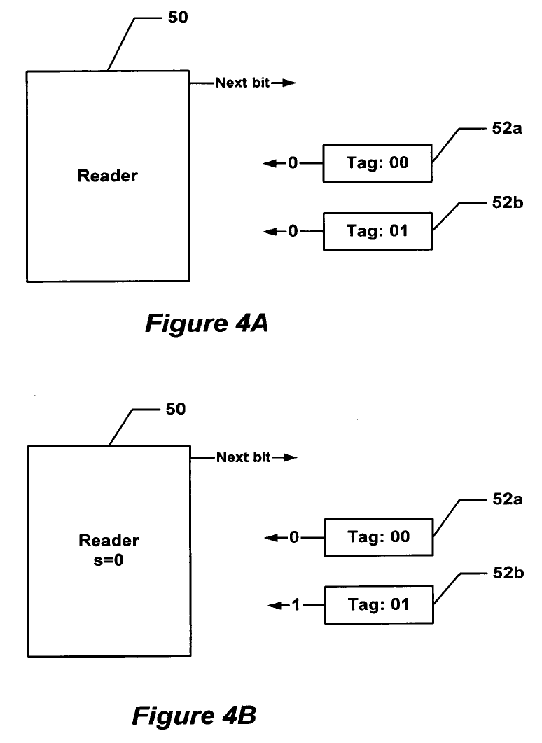

Referring now to FIG. 4A, a reader 50 reads the first bit from each of tags 52a and 52b. Since the first bit from each of the tags 52a, 52b are zeros, the bits do not collide.

Referring now to FIG. 4B, the reader 50 reads the next bit from each of the tags 52a, 52b. Since the next bit from tag 52a is a one and the next bit from tag 52b is a zero, the bits do collide. Thus, to singulate tag 01, the reader 50 responds with the logical exclusive or (XOR) of the two bits (i.e. 1=0 [symbol] 1) and thus tag 52a (i.e. the tag with bits 01) proceeds, while tag 52b (i.e. the tag with bits 00) ceases the protocol. This process is referred to as silent tree walking on two bits.

Eavesdroppers within the range of the backward channel may be able to obtain the entire ID. However, this silent tree walking scheme does effectively protect against long-range eavesdropping of the forward channel with little added complexity. Performance is identical to regular tree walking, since a tag will be singulated when it has broadcast its entire ID on the backward channel.

Readers may take advantage of the asymmetry of the forward and backward channels to transmit other sensitive values. Suppose a reader needs to transmit the value v to a singulated tag. That tag can generate a random number r as a one-time-pad, and transmit it in the clear on the backward channel. The reader may now send v [symbol] r over the forward channel. If eavesdroppers are outside the backward channel, they will only hear v [symbol] r, and v will be kept secure.

Another deterrent to forward channel snooping in RFID systems is to broadcast “chaff” commands from the reader, intended to confuse or dilute information collected by eavesdroppers. By negotiating a shared secret, these commands could be filtered, or “Winnowed”, by tags using a simple Media Access Control (MAC) address.

It should be appreciated that several other measures may also be taken to strengthen the security of RFID systems. First, RFID enabled environments can be equipped with devices to detect unauthorized read attempts or other transmissions on tag frequencies. Due to the strong signal strength in the forward channel, detecting read attempts is fairly simple. Deploying read detectors helps identify snooping attempts, or attempts to gain tag operating frequencies.

Another measure to detect denial of service is to design tags that “scream” when killed. This may entail transmitting a signal on a particular frequency. RFID enhanced “smart shelves” may be designed to detect the removal of items, unauthorized read attempts, or the killing of tags.

To enable end users to access the functionality of tags affixed to items they have purchased, a master key could be printed within a product's packaging, for example as a barcode or decimal number. After purchasing an item, a consumer could use the master key to toggle a tag from the hash-lock mode described above in conjunction with FIG. 2 to the randomized mode described above in conjunction with FIG. 3. The master key may also function as a key recovery mechanism, allowing users to unlock tags they have lost the keys to. It may also be used by recyclers or waste disposal facilities to unlock discarded tags when sorting garbage. Since the master key must be read optically from the interior of a package, adversaries cannot obtain the master key without obtaining the package itself. For further security, all functions using the master key could be required to use a physical contact channel, rather than the wireless RF channel.

Two final precautions take advantage of the physical properties of passively powered tags. First, readers should reject tag replies with anomalous response times or signal power levels. This is intended as a countermeasure to spoofing attempts by active devices with greater operating ranges than passive tags. Readers may also employ frequency hopping to avoid session hijacking. Passive tags may be designed such that their operating frequency is completely dictated by the reader. This makes implementing random frequency hopping trivial, since tags and readers do not need to synchronize random hops. Readers can just change frequencies, and the tags will follow.

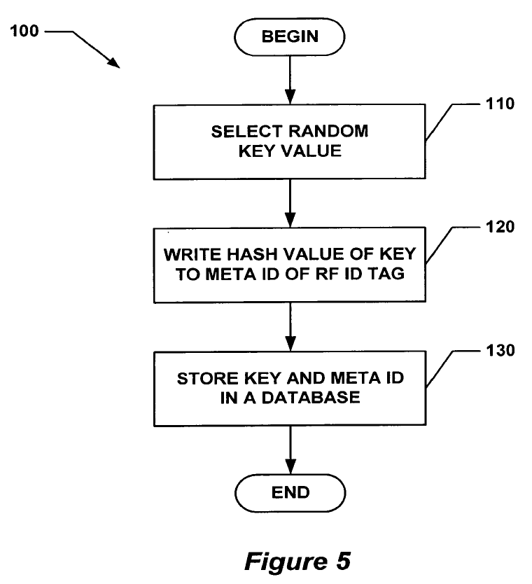

Flow charts of the presently disclosed methods are depicted in FIGS. 5-9. The rectangular elements are herein denoted “processing blocks” and represent computer software instructions or groups of instructions. The diamond shaped elements, are herein denoted “decision blocks,” represent computer software instructions, or groups of instructions which affect the execution of the computer software instructions represented by the processing blocks.

Alternatively, the processing and decision blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 5, a flow chart of the method 100 of locking an RFID tag is shown. The method 100 begins by selecting a random key value as shown in step 110. The key value is used in the provision of a metaID for the RFID tag.

In step 120 the hash value of the key is written to the metaID of the tag. The key is hashed, and the resulting value becomes the metaID of the particular tag. The metaID associated with the tag is provided by the RFID tag when the RFID tag is queried.

In step 130 the key and the metaID are stored in a database. The stored data will be used when the RFID tag is unlocked. Following completion of step 130 the method 100 ends.

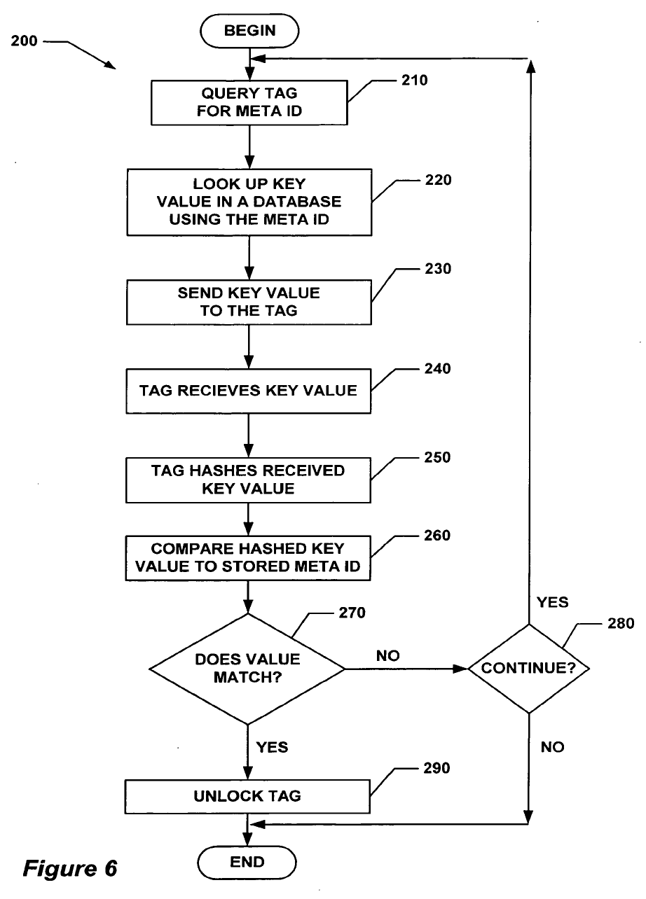

Referring now to FIG. 6, a method 200 of unlocking a tag is shown. The method 20 begins with step 210 in which the tag is queried for its metaID. When a tag is in the locked mode, the tag responds to queries by supplying its metaID. The locked tag will not provide any other information.

Step 220 states that the received metaID is used to look up the key associated with that metaID in the database. The lookup will provide the corresponding key for the metaID.

As shown in step 230 once the key is known the key is sent to the tag. The lookup of the metaID was used to provide the key, and this key is then sent to the tag.

In step 240 the tag receives the key value. The key value will be used to unlock the tag.

As shown in step 250 the tag hashes the received key value. The original metaID was obtained by performing a hash function on a key. A hashed key value (i.e., a second metaID) is obtained by hashing the received key.

In step 260 the hashed key value (second metaID) is then compared to the original metaID. If the hashed key value matches the metaID then the correct key value was obtained from the database.

In step 270 a comparison is made between the hashed key value and the original metaID. When the hashed key value does not match the original metaID, then step 280 is executed. When the value of the hashed key matches the metaID then step 290 is executed.

As shown in step 280 a decision is made whether to continue after the hashed key value of the received key does not match the metaID of the tag. If the decision to continue is made, steps 210 et. seq. are executed. When the decision is made not to continue further, then the process ends.

In step 290 the tag is unlocked. When a tag is unlocked, then additional information can be obtained from the tag (i.e., an Electronic Product Code, a serial number, etc.). Following step 290 the process ends.

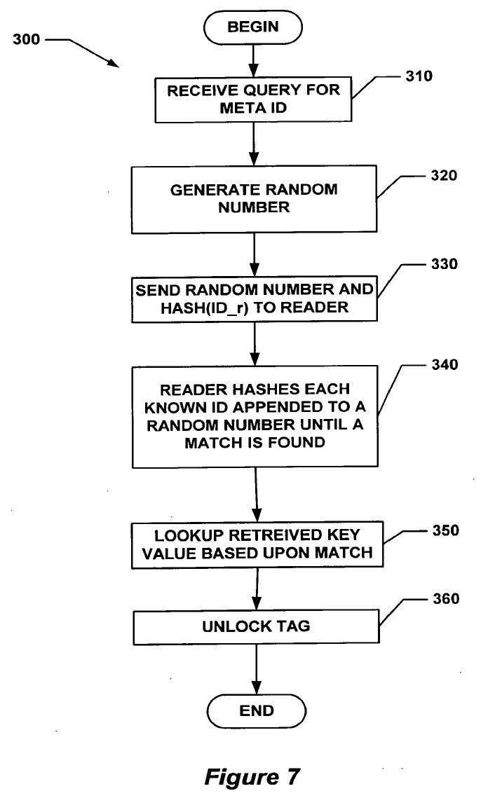

Referring now to FIG. 7, a flow chart 300 for unlocking a tag using a random hash function is shown. The process begins with the execution of step 310 in which the tag is queried for its metaID. When a tag is in the locked mode, the tag responds to queries by supplying its metaID. The locked tag will not provide any other information.

In step 320 a random number is generated. This is performed by the random number generator within the tag.

In step 330 the random number is appended to the hashed id and are provided to the reader.

As shown in step 340 the reader hashes each known ID appended to a random number until a match is found.

In step 350 a key is retrieved based upon the match. This key will be used to unlock the tag.

In step 360 the key is then used by the reader to unlock the tag. The tag unlock process has been described in detail above. Following the completion of step 360 the process ends.

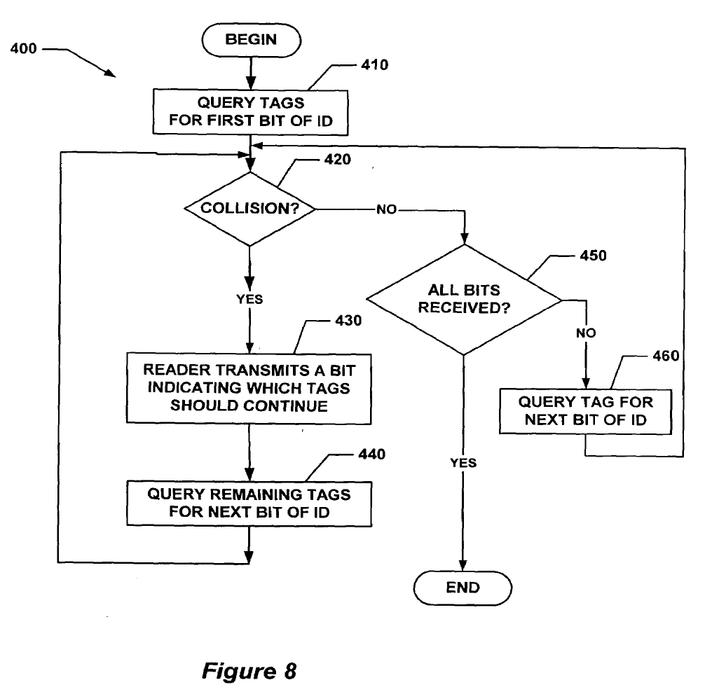

Referring now to FIG. 8 a flow chart for performing binary tree walking is shown. The process 400 begins with step 410 wherein a query is sent to one or more tags. The tags which are in the vicinity of the reader will respond with a first bit of their ID.

In step 420 a determination is made as to whether a collision has occurred. A collision occurs when two or more tags respond to the query with different values. When a collision occurs, step 430 is executed. When a collision does not occur, signifying that all tags responded with the same value, or that only a single tag responded, step 450 is executed.

In step 430, in response to the collision, the reader responds by transmitting a bit which indicates which tags should continue responding. For example, if some tags responded by transmitting a zero and others tags respond by transmitting a one, the reader would respond by transmitting a bit indicating that only the tags which responded with a one should continue. Alternately, the reader would respond by transmitting a bit indicating that only the tags which responded with a zero should continue. In an additional embodiment, referred to as silent tree walking, the bit sent by the reader may be a result of a function (e.g. an exclusive-or) of a previously received bit and the latest received bit, in order to prevent eavesdroppers from acquiring the tag information.

As shown in step 440 the remaining eligible tags are queried for the next bit. Following this step steps 420 et seq. are executed.

When a collision is not detected at step 420, then processing continues with step 450. In step 450 a check is made as to whether all the bits have been received. When all the bits have not been received then processing continues with step 460.

In step 460 the tag is queried for it's next bit. Following step 460, steps 420 et seq. are executed until an entire tag ID is received.

When the check made at step 450 determines that all the bits of the ID have been received the process ends.

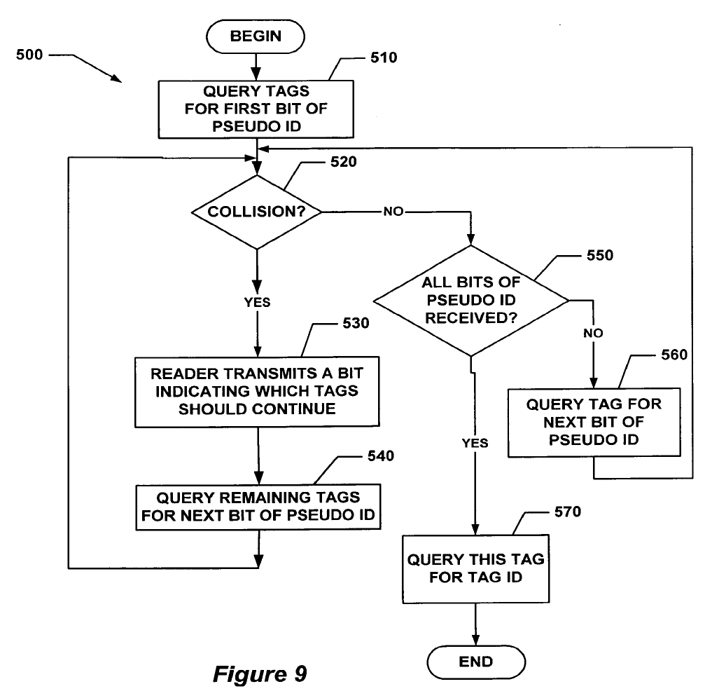

Referring now to FIG. 9 a flow chart for performing randomized tree walking is shown. The process 500 begins with 510 in which a query is sent to one or more tags. The tags which are in the vicinity of the reader respond with a first bit of their temporary random pseudo ID.

In step 520 a determination is made as to whether a collision has occurred. A collision occurs when two or more tags respond to the query with different values. When a collision occurs, step 530 is executed. When a collision does not occur, signifying that all tags responded with the same value, or that only a single tag responded, step 550 is executed.

In step 530, in response to a collision, the reader responds by transmitting a bit which indicates which tags should continue responding. For example, if tags some tags responded by transmitting a zero and others by transmitting a one, the reader would respond by transmitting a bit indicating that only the tags which responded with a one should continue. Alternately, the reader could respond by transmitting a bit indicating that only the tags which responded with a zero should continue.

As shown in step 540 the remaining eligible tags are queried for the next bit of their pseudo ID. Following this step, steps 520 et seq. are executed.

When a collision is not detected at step 520, then processing continues with step 550 in which a check is made as to whether all the bits of the pseudo ID have been received. When all the bits have not been received then processing continues with step 560.

In step 560 the tag is queried for it's next bit of its pseudo ID. Following step 560, steps 520 et seq. are executed until an entire tag pseudo ID is received.

Referring back to step 550, once all the bits of the pseudo ID have been received step 570 is executed.

In step 570 the tag is then queried for it's tag ID. Once the pseudo ID has been used to select a particular tag, the tag is then queried for it's actual tag ID.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. In a radio frequency identification (RFID) system that includes one or more RFID tag readers, an RFID tag comprising:
a tag communication device adapted to communicate with each of the one or more tag readers;
a cryptographic function element in communication with said tag communication device; and
a memory in communication with said tag communication device and said cryptographic function element.

2. The tag of claim 1 wherein said cryptographic function comprises a hash function.

3. The tag of claim 1 wherein said tag further comprises a random number generator in communication with said tag communication device.

4. The tag of claim 1 wherein in response to a query from one of said RFID tag readers, the tag provides a metaID to the RFID tag reader.

5. The tag of claim 1 wherein in response to a query from one of said RFID tag readers, said tag responds to queries by offering full functionality of said tag to the RFID tag reader.

6. A radio frequency identification (RFID) system comprising:
at least one RFID tag, each of the at least one RFID tags having a tag communication device, a memory and a cryptographic function element;
an off-tag storage device capable of storing therein a metaID and an associated key value; and
one or more tag readers adapted to query a tag for it's metaID and adapted to use the metaID to retrieve the associated key value from the storage device and adapted to then provide the key value to the tag.

7. The system of claim 7 further comprising a backward channel wherein said tag and said reader are capable of communicating over said backward channel.

8. The system of claim 7 further comprising a forward channel wherein said tag and said reader are capable of communicating over said forward channel.

9. The system of claim 8 wherein said forward channel has a greater range than said backward channel.

10. A method for locking a tag comprising:
selecting a random key value;
writing a hash value of the key to a metaID of the tag; and
placing said tag into a lock mode.

11. The method of claim 10 wherein said placing said tag into a lock mode comprises directing said tag to respond to queries by providing the metaID.

12. The method of claim 10 further comprising storing said key in a database.

13. The method of claim 12 further comprising storing said hash value in said database.

14. A method for unlocking a tag comprising:
querying a metaID from the tag;
using the metaID to look up an appropriate key in a database;
transmitting the key to the tag;
using the key to determine an identity of the tag; and
placing said tag in an unlocked mode.

15. The method of claim 14 wherein placing said tag in an unlocked mode comprises directing said tag to respond to queries by providing full functionality of said tag.

16. The method of claim 14 wherein said using the key comprises hashing the key to determine a secondary metaID and comparing said secondary metaID to said metaID.

17. The method of claim 16 wherein said unlocking said tag comprises unlocking said tag when said secondary metaID matches said metaID.

18. A method for unlocking a tag comprising:
querying the tag;
generating a random number with said tag;
sending said random number and a hashed ID to a reader;
hashing each known ID and random number until a match is found;
looking up a key based on said match;
transmitting the key to the tag;
using the key to determine an identity of the tag; and
placing said tag in an unlocked mode.

19. The method of claim 18 wherein placing said tag in an unlocked mode comprises directing said tag to respond to queries by providing full functionality of said tag.

20. The method of claim 18 wherein said using the key comprises hashing the key to determine a secondary metaID and comparing said secondary metaID to said metaID.

21. The method of claim 20 wherein said unlocking said tag comprises unlocking said tag when said secondary metaID matches said metaID.

22. A method of performing tag singulation comprising:
querying one or more tags for a first bit of the tag's ID;
determining whether there was a collision in response to said querying;
in response to a collision, then transmitting a bit to said tags indicating which tags should continue, querying remaining tags for a next bit of their ID, and repeating said step of determining whether there was a collision;
in response to a collision not occurring, determining whether all bits of the ID have been received, and in response to all bits of the ID not being received, querying said tag for a next bit of the ID and then repeating said step of determining whether there was a collision and in response to all bits of the ID having been received then using this ID for further communication with said tag.

23. The method of claim 22 wherein said transmitting a bit to said tags indicating which tags should continue comprises performing a function involving the last ID bit received and a previously received ID bit, and transmitting the result of said function to said tags, said result of said function indicating which tags should continue.

24. The method if claim 23 wherein said performing a function comprises performing an exclusive-or function.

25. A method of performing tag singulation comprising:
querying one or more tags for a first bit of the tag's pseudo ID;
determining whether there was a collision in response to said querying;
in response to a collision, then transmitting a bit to said tags indicating which tags should continue, querying remaining tags for a next bit of their pseudo ID, and repeating said step of determining whether there was a collision;
in response to a collision not occurring, determining whether all bits of the pseudo ID have been received, and in response to all bits of the pseudo ID not being received, querying said tag for a next bit of the pseudo ID and then repeating said step of determining whether there was a collision and in response to all bits of the pseudo ID having been received then querying this tag for said tag's ID.

26. The method of claim 25 wherein said transmitting a bit to said tags indicating which tags should continue comprises performing a function involving the last pseudo ID bit received and a previously received pseudo ID bit, and transmitting the result of said function to said tags, said result of said function indicating which tags should continue.

27. The method if claim 26 wherein said performing a function comprises performing an exclusive-or function.
